(19) United States
(12) Patent Application Publication
(10) Pub. No.: US 2009/0273475 A1
(43) Pub. Date: Nov. 5, 2009

(54) Anti-Theft Device

(76) Inventor: Stuart Seidel, Boca Raton, FL (US)

Correspondence Address: JOHN C. SMITH, ESQ., 2499 GLADES ROAD, SUITE 113, BOCA RATON, FL, 33431, US

(21) Appl. No.: 11/573,942

(22) PCT Filed: Aug. 19, 2005
(86) PCT No.: PCT/US05/29761

§ 371 Date: Feb. 19, 2007

Related U.S. Application Data
(60) Provisional application No. 60/522,129, filed on Aug. 19, 2004.
(60) Provisional application No. 60/593,274, filed on Jan. 3, 2005.

(51) Int. Cl. G08B 13/14

(52) U.S. Cl. 340/572.9

(57) ABSTRACT

An anti-theft tag with a locking mechanism that cannot be removed without breaking the lock. The anti-theft of tag has a removable lock that can be replaced after it is broken. The securing pin secures the lock in place in the first part of the tag. When the securing pin is withdrawn, the locking mechanism can be detached from the anti-theft tag. An optional method is provided in which the detacher arm channel is sealed to prevent access by a pick. The remaining parts of the tag, other than the lock, can be recycled. An alternative anti-theft tag uses a resettable locking mechanism. A detacher arm moves the lock from a locked to an unlocked position. Once unlocked, the lock remains in the unlocked position until reset with a key. A key aperture is hidden under the pin securing means.

### CROSS-REFERENCE TO RELATED APPLICATIONS

This application is related to, and claims the benefit of, the provisional patent application entitled “Recyclable EAS Tag,” filed Aug. 19, 2004, bearing U.S. Ser. No. 60/522,129 and naming Stuart Seidel, the named inventor herein, as sole inventor, the contents of which is specifically incorporated by reference herein in its entirety, the provisional patent application entitled “Anti-Theft Device,” filed Jan. 3, 2005, bearing U.S. Ser. No. 60/593,274 and naming Stuart Seidel. the named inventor herein, as sole inventor, and the co-pending PCT patent application number entitled “Anti-Theft Device,” filed Aug. 19, 2005, bearing PCT International Serial Number PCT/US2005/029761 and naming Stuart Seidel, the named inventor herein, as sole inventor, the contents of which is specifically incorporated by reference herein in its entirety.

### BACKGROUND OF INVENTION

1. Technical Field

The present invention relates to anti-theft devices which attach to commodities for preventing theft of the commodity. In particular, it relates to removable anti-theft devices having a tag which triggers an alarm when it is removed from a monitored area, and a removable securing member for attaching the tag to the commodity. Further, it relates to an improved method of recycling a tag by providing replaceable or resettable locking mechanisms. The tag reduced expenses for retailers due to a new cycle of use introduced by the invention. The anti-theft tag is shipped directly from the tag manufacturer to the product manufacturer (e.g., clothing manufacturer, etc.), the product manufacturer ships the complete product with tag to the retailer, who removes the tag at the point-of-sale and returns it to the tag manufacturer.

2. Background

Theft of all kinds has been an ongoing problem for virtually all retail establishments. One kind of theft: shoplifting, has caused substantial damage to retailers due to its widespread nature. In an attempt to address this problem, a variety of devices have been developed to limit shoplifting losses by automatically alerting the retailer when an item of merchandise is being illegally removed from the premises.

One type of anti-theft device is the anti-theft tag. An anti-theft tag is typically a small device which is secured to an item. The anti-theft tag typically includes a tuned circuit or antenna device which communicates with detectors placed at the entrances to the retailer's premises. When the detector senses a tag being removed from the store, it alerts the retailer via an alarm that is controlled by the detector.

Anti-theft tags of this type typically contain a first part which holds the tuned circuit or antenna, along with mechanical methods of securing the first part to a second part which is a securing means. A securing means is typically a cap-like structure with a securing pin. The securing pin is pushed through an item, such as a garment, and then secured to the first part. Once a customer has made a purchase, the employee removes the anti-theft tag so the customer can take the item out of the store without setting off an alarm.

The mechanical means to remove the securing means from the anti-theft tag was originally a probe which would be inserted into the anti-theft tag and apply pressure to the securing means to force it to release the pin. Unfortunately, shoplifters quickly developed mechanical devices to insert into the anti-theft tag and allow it to be removed from the inventory item. In response, the anti-theft industry has developed a variety of devices designed to defeat the attempts of shoplifters to remove anti-theft tags.

While anti-theft tag is safe retailers is substantial amount of expense by reducing theft, they are also costly. Currently, retailers attach anti-theft tags onto their products at the retail location. Unfortunately, the cost of attaching anti-theft tags onto garments is substantial for retailers. In addition, or more expensive labor costs are particular area, the more expensive it is to have employee's attach these anti-theft tags at the retail establishments. It would be desirable to have a method of reducing retailer costs by eliminating or reducing the cost of attaching anti-theft tags to merchandise.

While the prior art has provided numerous types of anti-theft tags, it has failed to provide an inexpensive method of handling, attaching, and removing the anti-theft tags during the course of business.

### SUMMARY OF INVENTION

The present invention solves the foregoing problems by providing an efficient method of pre-attaching anti-theft takes to merchandise prior to shipment to the retailer. The system uses breakable, or resettable, locking mechanisms which only allow the antitheft tag to be used once by a retailer. Initially, the antitheft tag manufacturer ships the anti-theft tags to a merchandise manufacturer who applies the anti-theft tags to the merchandise. The merchandise is then shipped, with the tag, the retailer. The retailer then removes the anti-theft tag at the point-of-sale, and returns the tag to the anti-theft tag manufacturer. This eliminates the retailer's expense related to attachment of the tags to the merchandise. The anti-theft tags used locking mechanisms which can only be used once by the retailer. In a first embodiment, a locking mechanism cannot be removed without breaking the lock. The tag has a removable lock that can be replaced after it is broken. The securing pin secures the lock in place in the first part of the tag. The lock is broken when the tag is removed. When the securing pin is withdrawn, the components of the tag are removed from the item. The lock is a discrete component of the tag, and is removed from the first part of the tag such that the remaining parts of the tag can be shipped back to the manufacturer for refurbishing. The manufacturer will replace the locks and recycle the remaining parts of the tag.

An alternative anti-theft tag uses a resettable locking mechanism. A detacher arm moves the lock from a locked to an unlocked position. Once unlocked, the lock remains in the unlocked position until reset with a key by the anti-theft tag manufacturer. The key aperture is hidden under the pin securing means. These embodiments ensure that the anti-theft tags are returned to the tag manufacturer for preparation for shipment to the merchandise manufacturer.

### BRIEF DESCRIPTION OF THE DRAWINGS

FIG. 1A is a top view of a preferred embodiment of the bottom portion of an anti-theft tag which illustrates the compartment used to hold the replaceable lock.

FIG. 1B is a top view of a preferred embodiment of the bottom portion of an anti-theft tag which illustrates the compartment used to hold the replaceable lock, and also illustrates an antenna device.

FIG. 1C is a side view of a preferred embodiment of the bottom portion of an anti-theft tag which illustrates the compartment used to hold the replaceable lock.

FIG. 2 is a side view of the preferred embodiment of the top portion of an anti-theft tag which illustrates the compartment used to hold the replaceable lock.

FIG. 3A is a top view of the preferred embodiment of a replaceable lock for an anti-theft tag.

FIG. 3B is an end view of the preferred embodiment of a replaceable lock for an anti-theft tag.

FIG. 3C is a side view of the preferred embodiment of a replaceable lock for an anti-theft tag.

FIG. 4 is a side view of a preferred embodiment of the interior of an anti-theft tag which illustrates a pick being inserted into the input area of the detacher arm chamber. This figure illustrates the pick being routed into the dead-end chamber.

FIG. 5 is a top external view of an alternative preferred embodiment which uses a resettable key actuated lock.

FIG. 6 is a top internal view of an alternative preferred embodiment which uses a resettable key actuated lock.

### DETAILED DESCRIPTION OF THE PREFERRED EMBODIMENT

Prior to a detailed discussion of the figures, a general overview of the system will be presented. For purposes of this disclosure, the term “pick” will be used to refer to any device used by an unauthorized person to attempt to release the anti-theft tag from its securing member.

This invention provides new embodiments that are improvements over the prior art. In particular, the invention provides reusable anti-theft tags that reduce cost, are more convenient for the consumer, and are better for the environment.

In a preferred embodiment, the invention provides replaceable locks which are designed to be discarded while the remainder of the lock is reused. In an alternative embodiment, a locking mechanism is provided that remains in the unlocked position when the detacher arm is inserted into the anti-theft tag. A key slot is hidden under the securing pin which is used to return the anti-theft tag to the locked position.

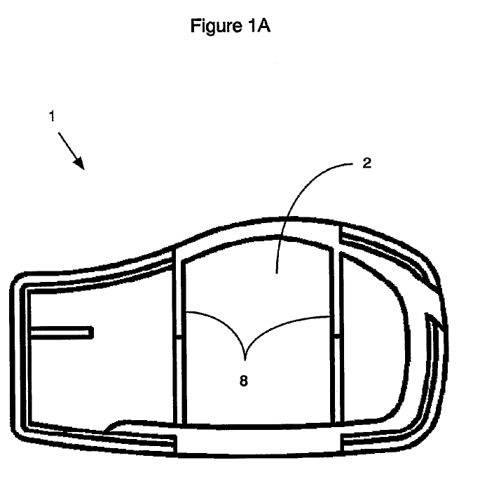

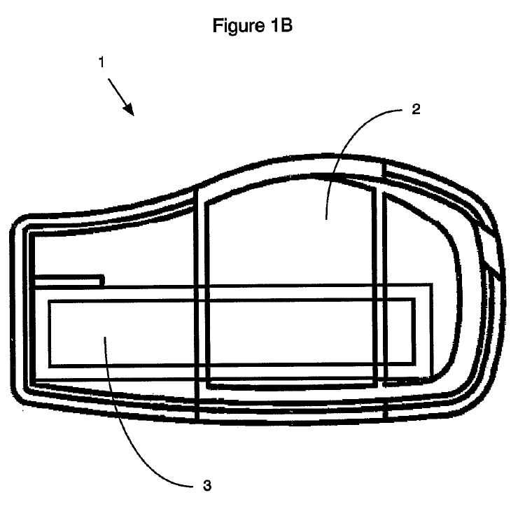

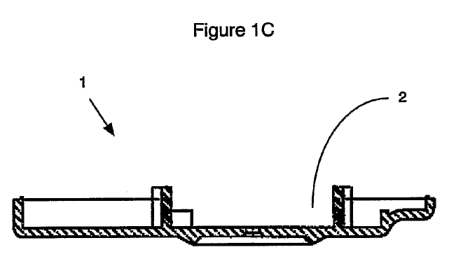

FIG. 1A is a top view of a preferred embodiment of the bottom portion 1 of an anti-theft tag which illustrates the compartment 2 used to hold the replaceable lock 6. This figure also illustrates the guide rails 8 which hold the replaceable lock 6 in the correct position when it is being inserted or withdrawn from the anti-theft tag 7. The compartment 2 is defined by the guide rails 8 and is preferably sized such that the replaceable lock 6 can be snugly held when inserted, but also able to be slid into or out of the anti-theft tag 7 when desired.

FIG. 1B is a top view of a preferred embodiment of the bottom portion 1 of an anti-theft tag 7 which illustrates the compartment 2 used to hold the replaceable lock 6, and also illustrates an antenna device 3.

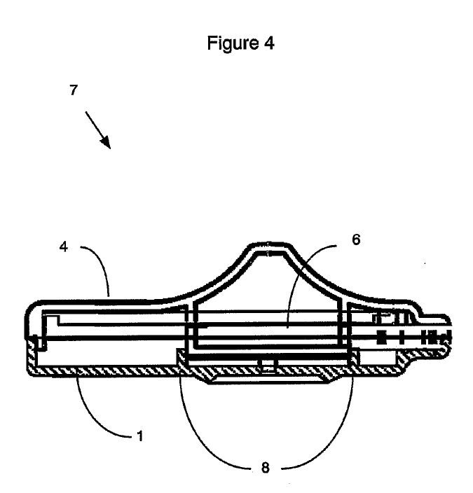

FIG. 1C is a side view of a preferred embodiment of the bottom portion 1 of an anti-theft tag 7 (shown in FIG. 4) which illustrates the compartment 2 used to hold the replaceable lock 6.

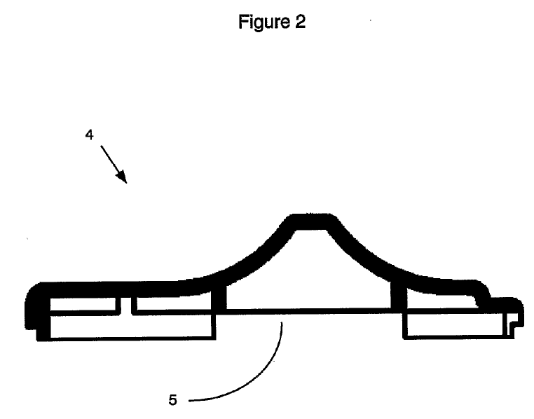

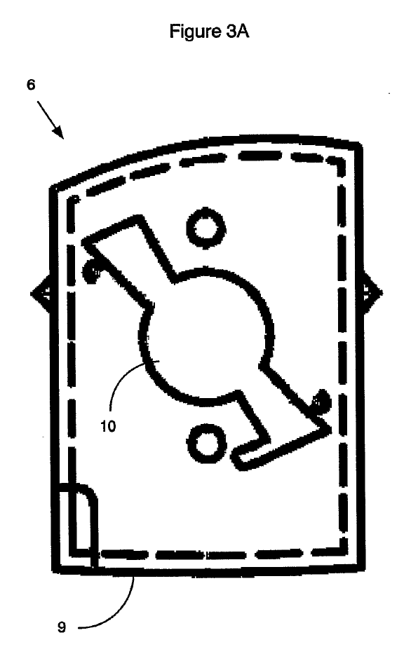

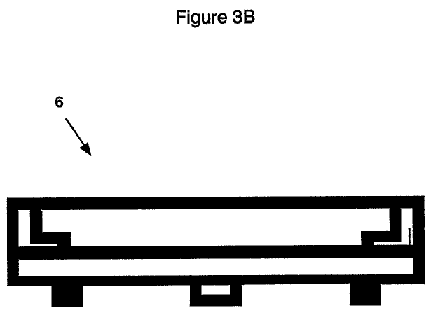

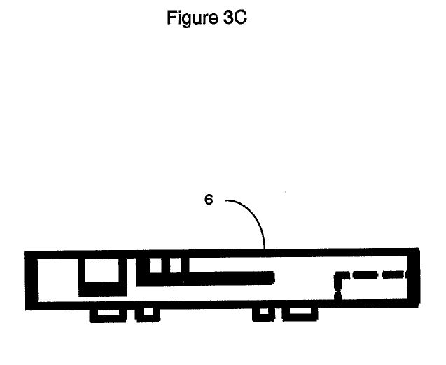

FIG. 2 is a side view of the preferred embodiment of the top portion 4 of an anti-theft tag 7 which illustrates the compartment 5 used to hold the replaceable lock 6 (shown in FIGS. 3A-C). Compartments 2 and 5 are aligned with one another such that when the antitheft tag 7 is assembled, they form an enclosed compartment which is sized to accommodate a replaceable lock 6.

FIG. 3A is a top view of the preferred embodiment of a replaceable lock 6 for an antitheft tag 7. Replaceable lock 6 has an outer case 9 and an inner locking mechanism 10. The inner locking mechanism 10 can be a C-clip retaining device, which is commonly used for anti-theft tags 7. Of course, any suitable type of locking mechanism can also be used.

Optionally, replaceable lock 6 can be a sealed device which will prevent picks from opening the lock. In this configuration, the detacher arm will break through an entry wall in the replaceable lock 6 to force it to open.

FIG. 3B is an end view of the preferred embodiment of a replaceable lock 6 for an anti-theft tag 7.

FIG. 3C is a side view of the preferred embodiment of a replaceable lock 6 for an anti-theft tag 7.

FIG. 4 is a side view of a preferred embodiment of the interior of an anti-theft tag 7. As can be seen in this figure, guide rails 8 securely position the replaceable lock 6 within the anti-theft tag 7.

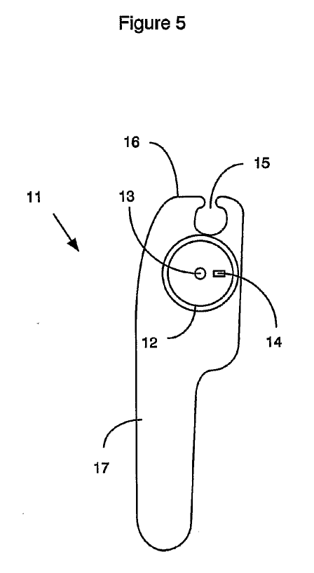

FIG. 5 is a top view of an alternative preferred embodiment of an anti-theft tag 11 which uses a key actuated resettable lock. Anti-theft tag 11 has an outer body 17 that encases the locking mechanism and the antenna device 3. The securing pin (not shown) is inserted through aperture 13 and secured by the locking mechanism. Also shown in this figure is a raised retaining ring 12 which is sized to accommodate the button (not shown) attached to the securing pin. The raised retaining ring 12 provides stabilization by preventing the button from moving. In addition, it also makes it more difficult for a thief to pry the button and securing pin from the anti-theft tag 11.

In this embodiment, the anti-theft tag 111 is released by a detacher arm (not shown) that is inserted into an aperture 16 on the forward edge of the anti-theft tag 11. The anti-theft tag 11 is secured to the detaching mechanism by placing aperture 15 over a retaining post (not shown) on the detaching mechanism. When the detacher arm releases the anti-theft tag 11, the lock is held in the open position. To reactivate the lock, a key (not shown) is inserted into key aperture 14. The key is used to provide access to the lock in order to reset it.

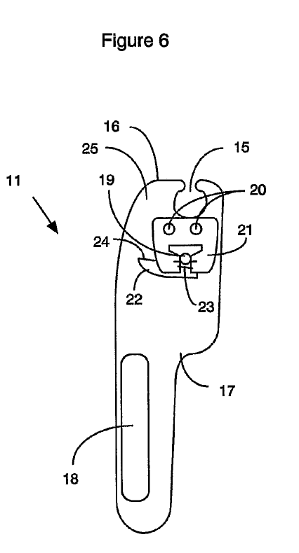

FIG. 6 is a top internal view of an alternative preferred embodiment of the anti-theft tag 11 which uses a key actuated lock. Shown in this figure is a C-clip 21 that is used to grasp the securing pin 19. The C-clip 21 is secured to the body 17 of the anti-theft tag 11 by posts 22. When the anti-theft tag 11 is unlocked, a detacher arm is inserted though aperture 16 and along path 25 until it presses against the edge 24 of lever arm 22. As lever arm 22 is pressed to unlock the anti-theft tag 11, it also rotates locking bracket 23, which is attached to lever arm 22. When locking bracket 23 is sufficiently rotated, it locks C-clip 21 in the open position. Locking bracket 23 is held in the open position by notches (not shown) in the C-clip 21.

When the user decides to activate the anti-theft tag 11, a key is inserted through key aperture 14 and applies pressure against locking bracket 23 to rotate it out of the notches and back to the closed position. In the preferred embodiment, the lever arm 22 is spring loaded. Once the locking bracket 23 is released by the key and begins moving toward the closed position, the spring (not shown) will urge the locking bracket back to a fully restored closed position.

Also illustrated in this figure is antenna device 18.

As can be seen from the foregoing, the breakable or resettable blocking mechanisms set forth herein provided the retailer with low-cost method of providing anti-theft protection by shifting the cost of attaching the anti-theft tags to the merchandise manufacturer. The embodiments provided herein disclose blocking mechanisms which are repaired or reset by the anti-theft tag manufacturer. As a result, the retailer needs only to remove the anti-theft tags from the merchandise, and ship them in bulk to the anti-theft tag manufacturer.

While the invention has been described with respect to a preferred embodiment thereof, it will be understood by those skilled in the art that various changes in detail may be made therein without departing from the spirit, scope, and teaching of the invention. For example, the material used to construct the components of the anti-theft tag may be anything suitable for their purpose, the size and shape of the anti-theft tag can vary, etc. Accordingly, the invention herein disclosed is to be limited only as specified in the following claims.

I claim:

1. An anti-theft tag, further comprising:
a bottom portion having a breakable lock;
a top portion having a securing pin that attaches to the bottom portion; and
the breakable lock secures the securing pin to the bottom portion prior to being broken, and releasing the securing pin after being broken.

2. An anti-theft tag, as a claim 1, further comprising:
the securing pin having sufficient size to extend into, and the snugly and securely held by the breakable lock, and further having sufficient length to secure an item of merchandise between the top portion in the bottom portion.

3. An antitheft tag, as a claim 2, wherein:
the pin disengages when the breakable lock is broken.

4. An anti-theft tag, further comprising:
a bottom portion having a resettable lock;
a top portion having a securing pin that extends through a pin channel in the top portion a sufficient distance to be grasped by the resettable lock, the securing pin securing the top portion to the bottom portion while the pin is grasped by the resettable lock;
a detacher device having a detacher arm with a length sufficient to enter the anti-theft tag and move the resettable lock from the lock to the unlocked position; and
the resettable lock remains in the unlocked position until reset.

5. An anti-theft tag, as a claim 4, wherein:
the top portion detaches from the bottom portion when the resettable lock is moved to the unlocked position.

6. An anti-theft tag, as a claim 5, wherein:
the resettable lock is reset by a key.

7. An anti-theft tag, as a claim 6, wherein:
an aperture for the key, allowing access to the resettable lock, is hidden under the top portion when the top portion in the bottom portion are secured together by the securing pin.

8. An anti-theft tag, as a claim 4, further comprising:
a C-clip;
a lever arm pivotably attached to the C-clip such that when the lever arm is moved, the C-clip is moved between an open and a closed position;
a locking bracket attached to the lever arm such that when the lever arm is moved sufficiently toward the open position, locking bracket will hold the C-clip in the open position;
means to secure the locking bracket in the open position;
a key aperture, aligned with the locking bracket; and
a key sized to fit through the key aperture, and further sized such that when rotated, it will release the locking bracket from the open position;
whereby, the anti-theft tag, when opened, will remain in the open position until it is returned to the closed position under control of the key.

9. A method of reusing anti-theft tags, including the steps of:
preparing a plurality of anti-theft tags having breakable or reusable locks, such that the anti-theft tags are in a lockable configuration;
transferring the plurality of anti-theft tags to a merchandise manufacturer for attachment to merchandise;
transferring the merchandise, which have anti-theft tag attached to them, from the merchandise manufacturer to a retailer;
detaching the anti-theft tag by breaking or unlocking the lock, and transferring the unlocked anti-theft tags to a tag manufacturer; and
repeating for foregoing steps.

10. A method, as a claim 1, including the additional step of:
securing an item to the anti-theft tag by inserting a securing pin into the breakable lock, and grasping the securing pin with breakable lock such that the securing pin is released only when the breakable lock is broken.

11. A method, as in claim 10, including the additional steps of:
dividing the anti-theft tag into a top portion and a bottom portion, the bottom portion containing the breakable lock; and
attaching the securing pin to the top portion of the anti-theft tag, and extending the securing pin into the bottom portion a sufficient distance to secure it to the breakable lock.

12. A method, as in claim 11, including the additional step of:
attaching the securing pin to the anti-theft tag by extending the securing pin into the antitheft tag a sufficient distance to secure it to the breakable lock.

13. A method, as in claim 12, including the additional step of:
detaching the securing pin from the anti-theft tag by breaking the breakable lock such that the securing pin is released from the breakable lock.

14. A method, as in claim 13, including the additional step of:
refurbishing the anti-theft tag by replacing the breakable lock.

15. A method, as in claim 13, including the additional step of:
breaking the breakable lock with a detacher arm that extends from a detacher device into the anti-theft tag.

16. A method, as a claim 15, including the additional steps:
securing and releasing the securing pin with a lever arm pivotably attached to a C-clip such that when the lever arm is moved, the C-clip is moved between a lock and an unlocked position;
using a locking bracket attached to hold the C-clip in the open position when the lever arm is moved sufficiently toward the open position.

17. A method, as in claim 16, including the additional steps of:
using a key, sized to fit through the key aperture, and further sized such that when rotated, it will release the locking bracket from the open position;
whereby, the anti-theft tag, when opened, will remain in the open position until it is returned to the closed position under control of the key.
